(19) United States
(12) Patent Application Publication
(10) Pub. No.: US 2020/0362771 A1
(43) Pub. Date: Nov. 19, 2020

(54) VALVE

(71) Applicant: Cummins Ltd., London (GB)

(72) Inventors: Richard Goodyear, West Yorkshire (GB); Iain M. Taylor, West Yorkshire (GB); Mark R. Holden, West Yorkshire (GB)

(21) Appl. No.: 16/639,891

(22) PCT Filed: Aug. 17, 2018
(86) PCT No.: PCT/GB2018/052340

§ 371 Date: Feb. 18, 2020

(30) Foreign Application Priority Data
Aug. 18, 2017 (GB) 1713305.9

(51) Int. Cl. F02D 9/10; F02D 9/04; F16K 1/22

(52) U.S. Cl. CPC F02D 9/106; F02D 9/04; F05D 2220/40; F01N 2240/36; F16K 1/224

(57) ABSTRACT

An exhaust throttle valve configured for use with a turbocharger. The exhaust throttle valve comprising a housing defining a duct configured to receive exhaust gas discharged from an outlet of the turbocharger; a valve member disposed within the duct and being movable between an open configuration in which flow of exhaust gas through the duct is permitted and a closed configuration the flow of exhaust gas through the duct is prevented or restricted; and a bearing member received by a bore of the housing and configured to support the valve member for rotation about a valve axis. The bore is closed at one end so as to substantially prevent leakage of exhaust gas through the bore.

### CROSS-REFERENCE TO RELATED APPLICATIONS

The present application is a National Stage Application under 35 U.S.C. § 371 of PCT Application No. PCT/GB2018/052340, filed Aug. 17, 2018, which claims priority to U.K. Application No. 1713305.9, filed Aug. 18, 2017, the entire disclosures of which being hereby expressly incorporated herein by reference.

### BACKGROUND

Exhaust throttle valves are used to regulate the flow of exhaust gasses discharged from an internal combustion engine, such as, for example, within a vehicle. Exhaust gasses are typically collected from outlet ports of the internal combustion engine within an outlet manifold, and are channelled through ducting to an exhaust gas aftertreatment system before being released to atmosphere. Such exhaust throttle valves typically comprise a valve member disposed within the ducting, the valve member being moveable so as to selectively permit or restrict and/or substantially prevent the passage of exhaust gas through the ducting.

When the exhaust throttle valve is actuated to restrict or substantially block the ducting, the pressure of the exhaust gas upstream of the exhaust throttle valve (i.e. within the outlet manifold and the ducting) will increase. When the outlet ports of the internal combustion engine are opened to expel further exhaust gas, the increased pressure of the exhaust gas in the outlet manifold will be transferred into the engine cylinders and will act upon the piston head. This causes increased resistance to movement of the piston within the engine cylinder, thus reducing the speed of the engine. In this way, an exhaust throttle valve can be used to provide engine braking. Efficiency of engine braking can be increased where delivery of fuel to the engine is stopped simultaneously with the closing of the exhaust throttle valve.

Exhaust throttle valves may also be used with engine systems having a turbocharger. Such turbochargers typically comprise a compressor and a turbine mounted for rotation upon a common shaft, such that they move in unison. Kinetic energy is harvested by the turbine and used to power the compressor so as to increase the pressure of intake gas entering the engine, which results in a corresponding increase in the amount of power produced by the engine. In addition to the braking effect described above, when the exhaust throttle valve of a turbocharged engine system is closed, the exhaust throttle valve acts to substantially restrict or prevent the passage of exhaust gas through the turbine, reducing the amount of kinetic energy harvested by the turbine. Furthermore, during braking fuel is no longer delivered to the engine, and therefore less energy is available for the turbine to drive the compressor. As such, the increase in pressure of the intake gas caused by the compressor (i.e. the amount of “boost”) is reduced, and the therefore positive pressure exerted on the engine pistons by the compressed intake gas is also reduced. Because the exhaust throttle valve acts to restrict flow out of the turbine, as the air from the engine is exhausted to the outlet manifold, pressure in the outlet manifold increases. This makes it more difficult for the pistons of adjacent cylinders to exhaust the compressed air, and therefore the amount of work required to keep the engine turning is increased. This increases the amount of power absorbed by the engine and enhances the braking effect.

In other applications, exhaust throttle valves can be used to increase the efficiency of an exhaust gas aftertreatment system. Most aftertreatment systems are only able to function properly if the exhaust gas passing through them is sufficiently hot enough. Shortly after engine ignition and/or during periods of idling, the temperature of the exhaust gas may not be sufficient for the aftertreatment system to function. By restricting the flow of exhaust gas out of the engine, the engine must do more work in order to maintain its operational set point (i.e. a particular engine speed or output power). This is achieved by injecting more fuel into to engine, which results in an increase in the temperature of the exhaust gas. The position of the exhaust throttle valve may be continuously adjusted so as to increase or decrease the amount of flow restriction provided and thereby maintain the temperature of the exhaust gas at a desired temperature. That is to say, there is no need for the exhaust throttle valve to be fully open or fully closed. The exhaust gas is then passed to the aftertreatment system where harmful substances will be removed.

In some known exhaust throttle valves, exhaust gasses may leak out of the ducting to atmosphere. Leaked exhaust gases do not pass through the aftertreatment system, and may therefore contain environmentally damaging emissions.

### SUMMARY

It is an object of the present disclosure to obviate or mitigate leakage of exhaust gas from an exhaust throttle valve. It is a further embodiment of the disclosure to provide an improved or alternative exhaust throttle valve. It is another object of the disclosure to provide an improved or alternative turbocharger system with an exhaust throttle valve.

According to a first aspect of the disclosure, there is provided an exhaust throttle valve configured for use with a turbocharger, wherein the exhaust throttle valve comprises: a housing defining a duct configured to receive exhaust gas discharged from an outlet of the turbocharger; a valve member disposed within the duct and being movable between an open configuration in which flow of exhaust gas through the duct is permitted and a closed configuration the flow of exhaust gas through the duct is prevented or restricted; and a bearing member received by a bore of the housing and configured to support the valve member for rotation about a valve axis; wherein the bore is closed at one end so as to substantially prevent leakage of exhaust gas through the bore.

By “closed” it is meant that the end of the bore is blocked in some manner in order to substantially restrict or prevent the flow of exhaust gas along it. For example, the bore may be a blind hole, such that it only partially penetrates into the housing. In this case, it is not possible for exhaust gas to leak out of the bore to the surrounding environment as the bore does not provide a path for gas to flow to the surrounding environment. Additionally or alternatively, an object may be inserted into the bore to block the bore. The object may form a seal with the bore preventing the leakage of exhaust gas out of the bore.

Typically, exhaust gas passing through the exhaust throttle valve will not have been treated by an exhaust gas aftertreatment system and may therefore contain substances which are harmful to the environment. Because the bore is closed at one end, leakage out of the bore is substantially prevented or restricted and therefore the danger of untreated exhaust gases leaking out of exhaust throttle valve to the atmosphere is mitigated.

Because the exhaust throttle valve is configured to receive exhaust gas from the turbine, it will be appreciated that the exhaust throttle valve is positioned downstream of the turbine. The turbine extracts energy from the exhaust gas to drive a compressor, and therefore the pressure and temperature of the exhaust gas downstream of the turbine are generally lower than upstream of the turbine. As such, by positioning the exhaust throttle valve downstream of the turbine, a more lightweight construction of exhaust throttle valve can be used (i.e. thinner wall sections etc.) thus saving space and cost. Furthermore, where the exhaust throttle valve is used within a vehicle, there may be a limited amount of space upstream of the turbine between an exhaust manifold of the engine and an inlet of the turbine to accommodate the exhaust throttle valve. It is therefore advantageous that the exhaust throttle valve is positioned downstream of the turbine.

The bore may be a blind hole defined by the housing.

That is to say, the bore extends only partially into the housing, and does not fully penetrate the housing. As such, the bore does not comprise a path along which untreated exhaust gas may leak out of the duct to the atmosphere, and thus the danger of untreated exhaust gases leaking out of exhaust throttle valve to the atmosphere is mitigated.

The bore may be a through hole defined by the housing. The end of the bore may be closed by an object received by the bore.

That is to say, the bore extends through and substantially penetrates the housing. It will be appreciated that the object received by the bore may be the bearing member, in particular where the bearing member comprises a blind hole configured to receive a portion of the valve member.

The object may be a plug received by the bore so as to form a substantially air-tight seal therebetween.

It will be appreciated that the air-tight seal prevents or substantially reduces leakage of exhaust gas along the bore to the environment.

The bearing member may be a bush comprising a blind hole configured to receive a portion of a shaft of the valve member.

Because the bearing member is “blind”, there is no path for untreated exhaust gases to leak from the duct to the environment. In other embodiments the bearing member may be a bush comprising an aperture (or through bore) configured to receive a portion of a shaft of the valve member.

The bearing member may be received by the bore via an interference fit.

It will be appreciated that the presence of an interference fit between the bearing member and the bore is advantageous as the interference fit will substantially prevent exhaust gas passing along the interface between the bearing member and the bore.

The bearing member and the bore may each comprise stepped sections configured to form a labyrinth type seal when the bearing member is received by the bore.

It will be appreciated that the labyrinth seal further improves sealing quality and/or operates as a back-up in case the interference fit between the bearing member and the bore fails.

The valve member may be a butterfly valve member comprising a valve shaft defining the valve axis. The valve shaft may be at least partially received by the bearing member. The butterfly valve member may comprise a valve leaf extending in a direction orthogonal to the valve shaft (or valve axis). The valve leaf may be configured to rotate with the valve shaft so as be movable between said open configuration in which exhaust gas may pass through the exhaust throttle valve, and said closed configuration in which the valve leaf substantially prevents or restricts the flow of exhaust gas through the exhaust throttle valve.

The bearing member may be a first bearing member and the bore may be a first bore. The exhaust throttle valve may further comprise a second bearing member received within a second bore of the housing diametrically opposite the first bore. The valve member may extend from the duct to an exterior of the housing via said second bore.

Because the valve member extends outside of the housing, an external actuator can be used to exert a torque upon the valve member so as to cause the valve member to rotate between the open and closed positions.

The turbocharger system may comprise a turbine and wherein the exhaust throttle valve may be positioned downstream of an outlet of the turbine so as to receive exhaust gas from the turbine.

As set out above because the exhaust throttle valve is positioned downstream of the turbine, a more lightweight construction of exhaust throttle valve can be used saving space and cost. Furthermore, spatial and packaging constraints associated with positioning the exhaust throttle valve upstream of the turbine are avoided.

Although the duct of the first aspect of the disclosure is configured to receive exhaust gas discharged from an outlet of a turbocharger, it will be appreciated that in other embodiments of the disclosure, an exhaust throttle valve may be provided in which the duct is configured to receive exhaust gas from substantially anywhere downstream of an engine and not specifically from the outlet of a turbocharger.

According to a second aspect of the disclosure there is provided an exhaust throttle valve configured for use with a turbocharger, the exhaust throttle valve comprising: a housing defining a duct configured to receive exhaust gas discharged from an internal combustion engine; a valve member disposed within the duct and being movable between an open configuration in which flow of exhaust gas through the duct is permitted and a closed configuration the flow of exhaust gas through the duct is prevented or restricted; a bearing member received by a blind bore of the housing, wherein the bearing member comprises a blind bore configured to receive and support the valve member for rotation about a valve axis.

It will be appreciated that because the bore and the bearing member are “blind”, it is not possible for exhaust gas to leak out of the exhaust throttle valve via the bore. Accidental leakage of untreated exhaust gases from the duct to an exterior of the exhaust throttle valve is therefore substantially reduced. It will be appreciated that the exhaust throttle valve may be positioned upstream of an inlet of a turbine of the turbocharger, an in particular may be positioned downstream of an exhaust manifold of the internal combustion engine. Because both the bore and the bearing member are blind, this provides an extra level of safety to prevent the leakage of untreated exhaust gas out of the exhaust throttle valve. This is particularly advantageous upstream of the turbine where the temperature and pressure of the exhaust gas are higher than downstream of the turbine.

The turbocharger system may comprise a turbine and wherein the exhaust throttle valve is positioned upstream of an inlet of the turbine.

However, in other embodiments, the turbocharger system may comprise a turbine and the exhaust throttle valve may positioned downstream of an outlet of the turbine.

According to a third aspect of the disclosure there is provided an exhaust throttle valve configured for use with a turbocharger, wherein the exhaust throttle valve comprises: a housing defining a duct configured to receive exhaust gas discharged from an internal combustion engine; a valve member disposed within the duct and being movable between an open configuration in which flow of exhaust gas through the duct is permitted and a closed configuration in which the flow of exhaust gas through the duct is prevented or restricted; and a bearing member received by a bore of the housing and configured to support the valve member for rotation about a valve axis; wherein the bore is closed at one end so as to substantially prevent leakage of exhaust gas through the bore.

It will be appreciated that, where appropriate, optional features discussed above in relation to one aspect of the disclosure may equally be applied to another aspect of the disclosure.

### BRIEF DESCRIPTION OF THE DRAWINGS

A detailed description of various embodiments of the disclosure will now be described, by way of example only, with reference to the accompanying drawings, in which:

FIG. 1 is a schematic diagram of a turbocharged engine system comprising an exhaust throttle valve;

FIG. 2 is a cross-sectional view of a first embodiment of an exhaust throttle valve;

FIG. 3 is a schematic cross-sectional view of a portion of a second embodiment of an exhaust throttle valve; and

FIG. 4 is a schematic cross-sectional view of a portion of a third embodiment of an exhaust throttle valve.

### DETAILED DESCRIPTION OF EMBODIMENTS OF THE DISCLOSURE

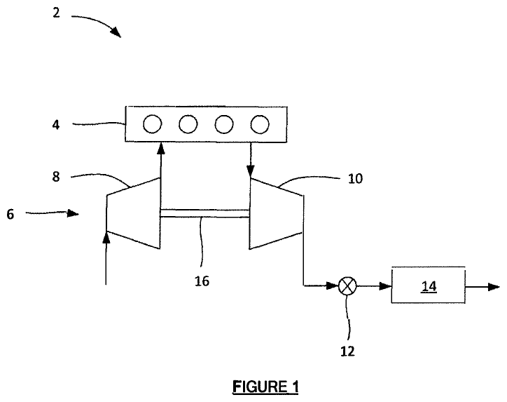

FIG. 1 shows a turbocharged engine system 2 comprising an internal combustion engine 4 and a turbocharger 6. The engine 4 may be for example a petrol or diesel engine, and is of the reciprocating piston and cylinder type. The turbocharger 6 comprises a compressor 8 and a turbine 10. The turbine 10 may be substantially any suitable type of turbine, such as, for example, a fixed or variable geometry turbine, a wastegated turbine, or a single or multiple (e.g. twin) entry turbine or the like. The engine system 2 further comprises an exhaust throttle valve 12 and an exhaust gas aftertreatment system 14. During use, intake air enters the compressor 8 where the pressure of the intake air is raised (or “boosted”) by the compressor 8. The high pressure intake air is then delivered to the engine 4 where it is mixed with fuel and undergoes combustion which is harnessed to produce power. Once combusted, the exhaust gases are expelled from the engine 4 and delivered to the turbine 10. The turbine 10 extracts kinetic energy from the exhaust gases and uses this to drive the compressor 8 via a turbocharger shaft 16. The exhaust gases then pass through the exhaust throttle valve 12 before being delivered to the aftertreatment system 14. The aftertreatment system 14 removes environmentally harmful substances from the exhaust gases (such as for example via filtering or catalytic conversion or the like) before releasing the treated exhaust gases to the environment.

It will be appreciated that in alternative embodiments, the exhaust throttle valve 12 may be positioned upstream of the turbine 10, for example between an exhaust manifold of the engine 4 and an inlet of the turbine 10. However, space between the exhaust manifold and the turbine inlet within a vehicle is generally limited and therefore in such arrangements the position of the turbocharger 6 relative to the engine 4 must be lowered so as to accommodate the exhaust throttle valve 12. This reduces the available space beneath the turbocharger 6 for operations, such as oil draining, and/or may lead to an increased space requirement for the engine system. Furthermore, the temperature of the exhaust gas upstream of the turbine 10 is generally higher than the exhaust gas downstream of the turbine 10. As such, in this arrangement the exhaust throttle valve 12 must be of a robust construction so as to withstand the higher exhaust gas temperatures. This can lead to an increase in size, weight and/or cost of the exhaust throttle valve. As such, it is preferable that the exhaust throttle valve is positioned downstream of the turbine 10, as shown in FIG. 1.

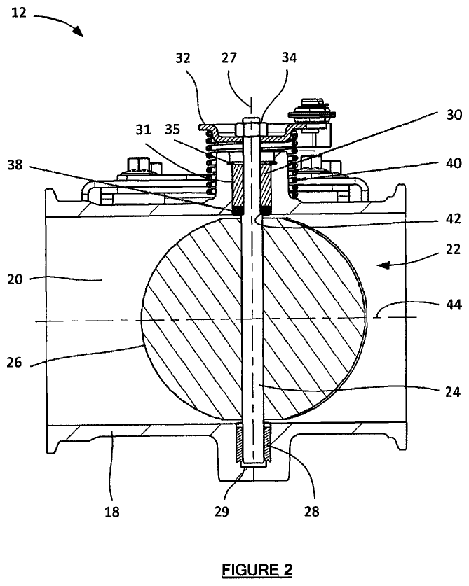

FIG. 2 shows a cross-sectional view of a first embodiment of an exhaust throttle valve 12. The exhaust throttle valve 12 comprises a housing 18 defining a generally cylindrical duct 20 for receiving and transmitting exhaust gases which have passed through the turbine 10. The housing may be made from any suitable rigid material which is able to withstand the relatively high temperature of the exhaust gas leaving the turbine 10, such as, for example, ductile iron, stainless steel, other metals or any other suitable material. The diameter of the duct 20 can be varied to substantially any size, as would be apparent to the skilled person, so as to suit the operational requirements of the engine system 2 within which it is installed. For example, for heavy duty applications the duct may be around 80 or 100 mm in diameter, for medium duty applications the duct may be around 50 or 60 mm in diameter, and for light duty applications the duct may be around 40 mm in diameter.

The exhaust throttle valve 12 in the present example takes the form of a butterfly valve and comprises a valve member 22. In particular, the valve member 22 comprises a valve shaft 24 and a valve leaf 26 which projects outwardly from the valve shaft 24. So as to withstand the relative high temperature of the exhaust gas leaving the turbine 10, the valve shaft 24 and valve leaf 26 is typically made from ductile iron, stainless steel, metal, or any other suitable material.

The valve shaft 24 is supported for rotation about a valve axis 27 via a lower bearing bush 28 and an upper bearing bush 30. The materials of the upper and lower bearing bushes 29, 30 and the valve shaft 24 may be chosen so as to provide reduced or low friction contact between the upper and lower bearing bushes 29, 30 and the valve shaft 24. Where the shaft 24 is made of metal, the upper and lower bearing bushes 28, 30 may be made from a metal which is dissimilar to that of the shaft 24. For example, the shaft 24 may be made from steel, and the upper and lower bearing bushes may be made from brass. Other examples of suitable materials for the upper and lower bearing bushes include bronze, cast iron, graphite or any other suitable material. In some embodiments, a lubricant may be introduced at the interface between the upper and lower bearing bushes 28, 30 and the shaft 24 so as to further reduce frictional resistance to movement of the shaft 24. Additionally or alternatively, the selection of the materials of the upper and lower bearing buses 29, 30 and the valve shaft 24 may be chosen based upon their wear properties, so as to increase the in-use life of the exhaust throttle valve 12. For example, the surface of the bearing bushes which interact with the valve member shaft may be coated with a low friction/wear coating.

The lower bearing bush 28 is received within a lower bore 29 which is a blind hole formed in the housing 18. The upper bearing bush 30 is received within an upper bore 31 which is a through-hole formed in the housing 18. In alternative embodiments of the exhaust throttle valve 12, the upper and lower bearing bushes 28, 30 may be replaced by substantially any suitable bearing member, for example a rolling element bearing, or the like. The valve shaft 24 extends through upper bore 31 from the duct 20 to an exterior of the housing 18. The portion of the valve shaft 24 which is external to the housing 18 is fixedly connected to a valve lever 32 via a nut 34. The valve lever 32 is connected to an actuator (not shown) which may be an electronic or pneumatic actuator, or the like.

The upper bearing bush 30 is held in position by a retaining ring 35 which is received within a groove 36 of the upper bore 31. So as to substantially reduce or prevent leakage of exhaust gas through the upper bore 31, the upper bore 31 is provided with a sealing member 38 configured to form a seal between the valve shaft 24 and the upper bore 31. The exhaust throttle valve 12 is further provided with a compression spring 40 configured to bear against an exterior of the housing 18 and a portion of the valve lever 32 so as to bias the valve lever 32 away from the housing 18. The valve shaft 24 comprises an inwardly-stepped shoulder 42 which bears against the sealing member 38 and thereby resists the biasing force applied by the compression spring 40 upon the valve lever 32. This has the effect that the valve member 22 is effectively “suspended” within the duct 22, such that the end of the valve shaft 24 closest to the lower bore 29 does not “bottom out” on the lower bore 29 thus preventing unnecessary wear.

During use, the actuator is activated so as to displace the valve lever 32 and exert a torque upon the valve shaft 24. This results in rotational movement of the valve member 22 between an open position and a closed position. The valve leaf 26 is generally plate-like circular baffle, and in the open position the circumference of the valve leaf 26 is aligned parallel to a central axis 44 of the duct 20, as shown in FIG. 2. This orientation of the valve leaf 26 presents as little resistance as possible to the exhaust gases travelling through the duct 20. In the closed position, the valve member is rotated 90° about the valve axis 27 so that the circumference of the valve leaf 26 extends as close as possible to the inside of the housing 18 defining the duct 20. When in the closed position, it will be appreciated that the valve leaf 26 acts as a physical barrier to substantially restrict or prevent exhaust gas entering the duct 20 from passing beyond the valve member 22. Typically, the valve member 22 is able to block approximately 90 to 99% of the cross-sectional area of the duct 20. Typically, a small amount of clearance must be provided between the housing 18 and the valve leaf 26 so as to permit the valve member to rotate.

When the valve member 22 is in the closed position, the pressure of the exhaust gas upstream of the valve member increases. The increased pressure puts mechanical strain upon the sealing member 38, dilating the sealing member 38 and increasing the risk that exhaust gases may leak through the upper bore 31 and to atmosphere without being filtered and treated by the aftertreatment system 14. Furthermore, it will be appreciated that in order to allow relative rotation between the valve shaft 24 and the upper and lower bearing bushes 28, 30, a small amount of clearance is provided therebetween. As such, it is generally possible for exhaust gases to pass along the interfaces between the valve shaft 24 and the upper and lower bearing bushes 28, 30 (unless, in the case of the upper bearing bush 30, they have been excluded by the presence of the sealing member 38). However, because the lower bore 29 comprises a blind hole, it will be appreciated that this acts to close the end of the lower bore 29 so that it is not possible for untreated exhaust gases to leak out of the lower bore 29 to the environment. As such, because the lower bore 29 is closed at one end, the exhaust throttle valve 12 reduces accidental leakage of untreated exhaust gas to the environment compared to an arrangement where the lower bore 29 has the same structure as the upper bore 31. This effectively cuts the amount of accidental leakage of exhaust gas from the exhaust throttle valve 12. The above notwithstanding, it will be appreciated that a small amount of exhaust gas may leak downstream of the valve member 22. However, any exhaust gas which leaks beyond the valve member 24 will be filtered and treated by the aftertreatment system 14, thus reducing harm to the environment.

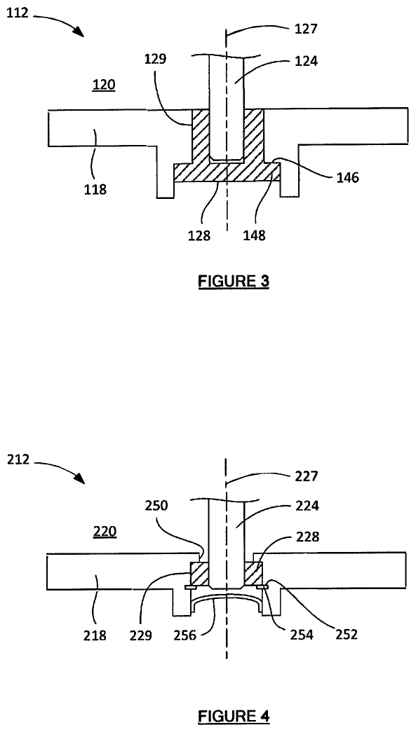

FIG. 3 shows a cross-sectional view of a portion of a second embodiment of an exhaust throttle valve 112. In FIG. 3, like reference numerals are used to refer to equivalent features of the second embodiment of the exhaust throttle valve 12 which are present in the first embodiment, prefixed with the number 1. Aside from the differences described below, it will be appreciated that the exhaust throttle valve 112 of the second embodiment may comprise substantially all of the same features as the first embodiment described above.

For clarity, only a lower portion of the exhaust throttle valve 112 is shown. The exhaust throttle valve 112 of the second embodiment comprises a housing 118 having a lower bore 129. The lower bore 129 is formed as a though-hole extending from the duct 120 to an exterior of the housing 118. A lower bearing bush 128 is received by the lower bore 129 via an interference fit, such that the lower bearing bush 128 is held steadfast within the lower bore 129. In particular, contact between the lower bore 129 and the lower bearing bush 128 is substantially air-tight, so that exhaust gases are prevented from travelling along the interface between the lower bearing bush 128 and the lower bore 129. The lower bearing bush 128 is generally cap-shaped, and in particular comprises a blind bore which receives an end of a valve shaft 124 so as to support the valve shaft 124 for rotation about a valve axis 127.

It will be appreciated that because the lower bearing bush 128 fits tightly against the housing 118 and comprises a blind hole, the lower bearing bush 128 therefore acts to close the lower bore 129 so as to substantially prevent exhaust gases from leaking out of the duct 120 to an exterior of the housing 118 via the lower bore 129. Additionally, the lower bore 129 comprises an outwardly stepped shoulder 146 and the lower bearing bush 128 comprises an outwardly extending flange 148 received by the shoulder 146 so as to form a labyrinth-type seal further preventing leakage of exhaust gas from the bore 129. Although not shown in FIG. 3, additional sealing members may be provided to further prevent leakage of exhaust gases through the lower bore 129, for example in the region below the lower bush 128. For example, a further cap could be located beyond the bearing bush 128 in the bore 129. The cap may be secured in the bore in any desired fashion—e.g. interference fit, adhesive, welding, staking, or corresponding screw threads on the cap and inside of the bore.

FIG. 4 shows a cross-sectional view of a portion of a third embodiment of an exhaust throttle valve 212. In FIG. 4, like reference numerals are used to refer to equivalent features of the third embodiment of the exhaust throttle valve 12 which are present in the first embodiment, prefixed with the number 2. Aside from the differences described below, it will be appreciated that the exhaust throttle valve 212 of the second embodiment may comprise substantially all of the same features as the first embodiment described above.

For clarity, only a lower portion of the exhaust throttle valve 212 is shown. The exhaust throttle valve 212 of the third embodiment comprises a housing 218 having a lower bore 229. The lower bore 229 is formed as a though-hole extending from the duct 220 to an exterior of the housing 218. A lower bearing bush 228 is received by the lower bore 229 via an interference fit, such that the lower bearing bush 228 is held steadfast within the lower bore 229. In particular, contact between the lower bore 229 and the lower bearing bush 228 is substantially air-tight, so that exhaust gases are prevented from travelling along the interface between the lower bearing bush 228 and the lower bore 229. The lower bearing bush 228 is a generally hollow cylinder through which an end of a valve shaft 224 is passed. The lower bore 229 comprises an inwardly stepped shoulder 250 and a lower retaining ring 252 which is received within a lower groove 254 formed in the lower bore 229. The lower bearing bush 228 is constrained at opposite ends by the shoulder 250 and the lower retaining ring 252 so as to hold the lower bearing bush 228 axially in place relative to a valve axis 227.

The exhaust throttle valve 212 further comprises a plug 256 received by the lower bore 229 beyond the end of the valve shaft 224. The plug 256 is generally bowl-shaped and has a U-shaped cross section. The sides of the bowl are configured to bias radially outwards from the valve axis 227 so as to bear against the lower bore 229 so as to form a substantially air-tight seal against the housing 218. In order to provide a good quality seal, the plug 256 is made from a resilient material such as for example steel, metal, rubber or plastic. It will be appreciated that the plug 256 acts to close the lower bore 229 so as to substantially prevent leakage of exhaust gases from the duct 220 to an exterior of the exhaust throttle valve 212 via the lower bore 229. The plug may be secured in the bore in any desired fashion—e.g. interference fit, adhesive, welding, staking, or corresponding screw threads on the plug and inside of the bore.

In alternative embodiments of the exhaust throttle valve 12, the lower bearing bush 28 may comprise a blind hole configured to receive an end of the valve shaft 24 and the lower bore 29 may also comprise a blind hole configured to receive the lower bearing bush 28.

The exhaust throttle valve may be positioned upstream of the turbine 10, and in particular between an exhaust manifold of the engine 4 and an inlet of the turbine 10.

Although the valve construction described above is a butterfly valve, it will be appreciated that any suitable type of valve may be used. For example, the valve may be a poppet valve or a barrel-shaped valve or the like.

It will be appreciated that the skilled person may readily be able to envisage alternative embodiments of the exhaust throttle valve 12 of the present disclosure in which the lower bore 29 is closed or sealed in a manner not described above, but which nonetheless fall within the scope of the claims. Such embodiments may require the use of additional sealing elements, coatings or the like.

1. An exhaust throttle valve configured for use with a turbocharger, wherein the exhaust throttle valve comprises:
a housing defining a duct configured to receive exhaust gas discharged from an outlet of the turbocharger;
a valve member disposed within the duct and being movable between an open configuration in which flow of exhaust gas through the duct is permitted and a closed configuration in which the flow of exhaust gas through the duct is prevented or restricted; and
a bearing member received by a bore of the housing and configured to support the valve member for rotation about a valve axis;
wherein the bore is closed at one end so as to substantially prevent leakage of exhaust gas through the bore.

2. An exhaust throttle valve according to claim 1, wherein the bore is a blind hole defined by the housing.

3. An exhaust throttle valve according to claim 1, wherein the bore is a through hole defined by the housing, and wherein the end of the bore is closed by an object received by the bore.

4. An exhaust throttle valve according to claim 3, wherein the object is a plug received by the bore so as to form a substantially air-tight seal therebetween.

5. An exhaust throttle valve according to claim 1, wherein the bearing member is a bush comprising a blind hole configured to receive a portion of a shaft of the valve member.

6. An exhaust throttle valve according to claim 1, wherein the bearing member received by the bore via an interference fit.

7. An exhaust throttle valve according to claim 1, wherein the bearing member and the bore each comprise stepped sections configured to form a labyrinth type seal when the bearing member is received by the bore.

8. An exhaust throttle valve according to claim 1, wherein the valve member is a butterfly valve member comprising a valve shaft defining the valve axis, the valve shaft being at least partially received by the bearing member, and a valve leaf extending in a direction orthogonal to the valve shaft, the valve leaf being configured to rotate with the valve shaft so as be movable between said open configuration in which exhaust gas may pass through the exhaust throttle valve, and said closed configuration in which the valve leaf substantially prevents or restricts the flow of exhaust gas through the exhaust throttle valve.

9. An exhaust throttle valve according to claim 1, wherein the bearing member is a first bearing member and the bore is a first bore, and wherein the exhaust throttle valve further comprises a second bearing member received within a second bore of the housing diametrically opposite the first bore, and wherein the valve member extends from the duct to an exterior of the housing via said second bore.

10. A turbocharger system comprising an exhaust throttle valve according to claim 1, wherein the turbocharger system comprises a turbine and wherein the exhaust throttle valve is positioned downstream of an outlet of the turbine so as to receive exhaust gas from the turbine.

11. An exhaust throttle valve configured for use with a turbocharger, the exhaust throttle valve comprising:
a housing defining a duct configured to receive exhaust gas discharged from an internal combustion engine;
a valve member disposed within the duct and being movable between an open configuration in which flow of exhaust gas through the duct is permitted and a closed configuration in which the flow of exhaust gas through the duct is prevented or restricted; and
a bearing member received by a blind bore of the housing;
wherein the bearing member comprises a blind bore configured to receive and support the valve member for rotation about a valve axis.

12. A turbocharger system comprising an exhaust throttle valve according to claim 11, wherein the turbocharger system comprises a turbine and wherein the exhaust throttle valve is positioned upstream of an inlet of the turbine.
